(19) United States
(12) Patent Application Publication
(10) Pub. No.: US 2012/0311944 A1
(43) Pub. Date: Dec. 13, 2012

(54) Anchor for metal door frames and process of fabricating same

(76) Inventor: Peter H. Stier, Spring Valley, MN (US)

(21) Appl. No.: 13/134,350

(22) Filed: Jun. 7, 2011

(51) Int. Cl. E06B 1/56; E06B 1/52; B23P 17/00; E06B 1/14

(52) U.S. Cl. 52/213; 29/897.3

(57) ABSTRACT

An anchor for supporting a metal door frame component from buckling or bending upon tightening of a fastener attaching the door frame component to a wall is disclosed having a hollow intermediate portion, a base portion located on one end of said intermediate portion and having a hole defined therein aligned with said intermediate portion, and a pair of opposed flanges extending outward from the other end of said intermediate portion. An automated process for fabricating such anchors in a punch press is also disclosed.

### BACKGROUND OF THE INVENTION

The present invention relates to a support device, or anchor, for hollow door frame assemblies, particularly hollow metal door frame assemblies, that provides support for a door frame component when the door frame component is attached to a structural component of a wall and an automated process for fabricating the same.

In standard construction, a door frame typically consists of two vertical jamb portions (one of which is commonly referred to as the striker jamb and the other of which is commonly referred to as the hinge jamb) and a header portion connecting the upper ends of the jamb portions. Such door components are attached to the structural components of a wall defining a door opening, and a door is attached by hinges to the hinge jamb and operable within the door frame between a closed position and an open position. The door components typically define a central striker portion which acts as a door stop to permit the door to open in only one direction.

In many applications, the door frame components are fabricated of metal and have the same generally channel shaped cross-sectional configuration. Such components have an intermediate striker portion, shoulder portions on either side of the striker portion, a flange portion on the opposite side of each of the shoulder portions extending at 90 degrees thereto and an inwardly extending return portion on the opposite side of each of the flange portions. In use, the components are attached to the structural components defining a door opening (i.e., studs or headers) in a wall by means of bolts, screws or other fasteners extending through a plurality of holes drilled or otherwise formed in the striker portion of the door components.

Metal door components formed in this manner have longitudinal and lateral strength, but are relatively weak against inward forces and tend to buckle or bend inwardly under forces created by attaching the components to the structural elements.

Different types of support devices (commonly referred to as “anchors”) have been used to support such metal door components against buckling or bending adjacent to the fastener. Such support devices are designed to be placed within the door frame components between a hole and the corresponding structural component of the wall to provide support to the striker portion adjacent to the hole to prevent buckling or bending of the door frame components upon insertion and tightening of a fastener through the hole and into the structural component.

One example of a support device of the prior art is a metal strap having a mid portion with a hole drilled or formed in it, two intermediate portions each extending at right angles to one end of the mid portion and two outer portions each extending at right angles outwardly from one end of one of the intermediate portions. The width of the mid portion is such that it can be received within the inside of the striker portion of a door frame component. The length of the intermediate portions is substantially the same as the distance between the interior or under side of the striker portion of a door frame component and the structural member when the door frame component is placed within the door opening. The width of the support device, as measured along the outer portions, is substantially the same as the width of the door frame component. In use, the mid portion of the support is positioned within the inside of the striker portion of the door frame component such that the hole in the device is aligned with a hole in the door frame component and the device rotated until the ends of the outer portions of the device engage the return portions of the door frame component to hold the device in place while a fastener is inserted and tightened through the hole and into the structural component of the wall.

The support device described in the preceding paragraph is easy to fabricate, but often lacks sufficient strength to prevent buckling or bending of the door frame component when the fastener is tightened.

Perhaps the most common and effective type of support device comprises a length of metal pipe, tubing or other hollow member with a metal strap welded across one end and extending outwardly on both sides of the hollow member, typically referred to as a “tube anchor”. A hole sufficient to permit the passage of a fastener is formed or drilled in the strap and aligned generally along the longitudinal axis of the tube. The combined height of the tube anchor is substantially the same as the distance between the interior or under side of the striker portion and the structural member when the door frame component is placed within the door opening. When the door frame component is being attached to the structural component, the tube anchor is placed within the interior of the component, with the open end of the tube anchor adjacent to a hole in the striker portion of the door frame component and the strap aligned along the length of the door frame component. The outer ends of the strap are manually deflected inwardly and the tube anchor rotated until the strap is aligned across the open end of the door frame component, with the outer ends of the strap inside one of the return portions. When the outer ends of the strap are released, the strap will engage the return portions to hold the tube anchor in place and align with the hole while the fastener is inserted and tightened through the hole and tube anchor and into the structural component.

The tube anchors described provide adequate support to prevent buckling or bending of the door frame component, but are typically constructed by hand, often at the site of installation, and are time consuming and troublesome to fabricate.

It is one object of the present invention to provide a support device for hollow metal door frame components that have sufficient strength to support the door frame component against buckling or bending upon insertion of a fastener attaching the door frame component to a structural member of a wall.

It is another object of the present invention to provide a support device for hollow metal door frame components that is machine fabricated.

It is a further object of the present invention to provide an automated process for fabricating a support device for hollow metal door frame components according to the present invention.

Toward those objects, a support device is provided comprising a hollow, tubular portion having a base portion at one end and a pair of opposed flanges projecting outwardly from the opposite end. The base portion defines a central opening aligned along the longitudinal axis of the tubular portion. The tubular portion comprises a pair of spaced, opposed sides having generally “U” shaped cross sections having a central web portion and spaced legs extending at right angles from the outer edges of the web portion, with the outside width of one side being slightly less than the inside width of the other side such that the outer ends of the legs of the latter may be slideably received within outer ends of the former. The flanges extend outwardly at right angles to top of the web portions of each side.

The support device of the present invention is fabricated by a die stamping process applied to a continuous ribbon of steel comprising the following steps undertaken at various stations in a die press on a segment of such ribbon:
(1) station A—punching a central hole in the metal ribbon;
(2) station B—punching an indexing hole and removing transverse webs of material between the sides of tubular portions of successive support devices;
(3) station C—removing material between successive support devices to form flanges extending from the ends of the tubular portions;
(4) station D—removing portions of longitudinal webs of material between successive anchors adjacent to an indexing hole;
(5) station E—bending the flanges downwardly at right angles to the web portions of the sides of the tubular portion of the anchor;
(6) station F—bending the legs of the sides of the tubular portion upwardly at right angles to the web portions of the sides of the tubular portion;
(7) station G—bending the web portions of the tubular portion upwardly at right angles to the base portion of the tubular portion such that the end of the legs of one of the sides of the tubular portion extend between the end of the legs of the other side;
(8) station H—forming the tubular portion to its final configuration; and
(9) station I—cutting off the formed anchor from the ribbon of metal.

### DESCRIPTION OF THE DRAWING

FIG. 1 is an elevational view of a conventional door frame.

FIG. 2 is a perspective view of a portion of a hollow metal door.

FIG. 3 is an elevational view of a support device according to the present invention.

FIG. 4 is a cross sectional view of a support device according to the present invention taken along the line 4-4 of FIG. 3.

FIG. 5 is a cross sectional view of a support device according to the present invention taken along the line 5-5 of FIG. 3.

FIG. 6 is a cross sectional view of a support device according to the present invention in place within a metal door frame component attached to the structural components of a wall, taken along the line 6-6 of FIG. 1.

FIG. 7 is a side view showing a steel coil, coil handler, controller, press and die arrangement for fabricating a support device according to the present invention.

FIG. 8 is a top perspective view of a ribbon of steel illustrating the configuration of multiple support devices according to the present invention at various stages of fabrication according to the process of the present invention.

FIG. 9 is a perspective plan view of a ribbon of steel illustrating the configuration of multiple support devices according to the present invention.

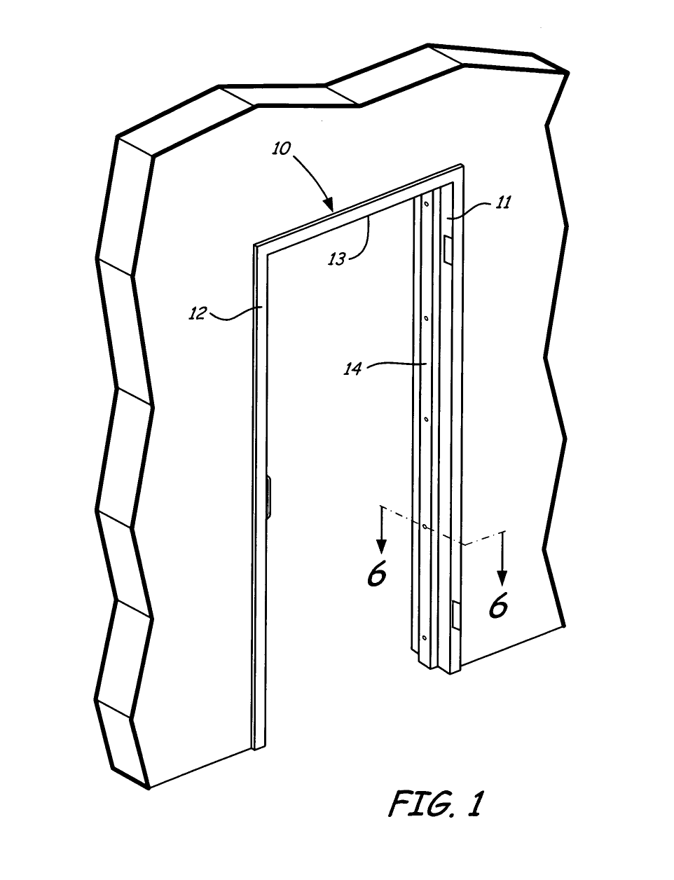

### DETAILED DESCRIPTION OF THE PREFERRED EMBODIMENT

Referring to the drawing, wherein like numerals represent like elements throughout the several views, there is shown a convention door frame assembly generally designated by the numeral 10 comprising three door frame components: a hinge jamb 11, a striker jamb 12 and a header jamb 13 connected across the tops of jambs 11 and 12. All components have the same cross-sectional shape, including a protruding striker portion 14. A door is hingedly attached to hinge jamb 11. Striker portion 14 acts as a stop and permits the door to open and close in only one direction.

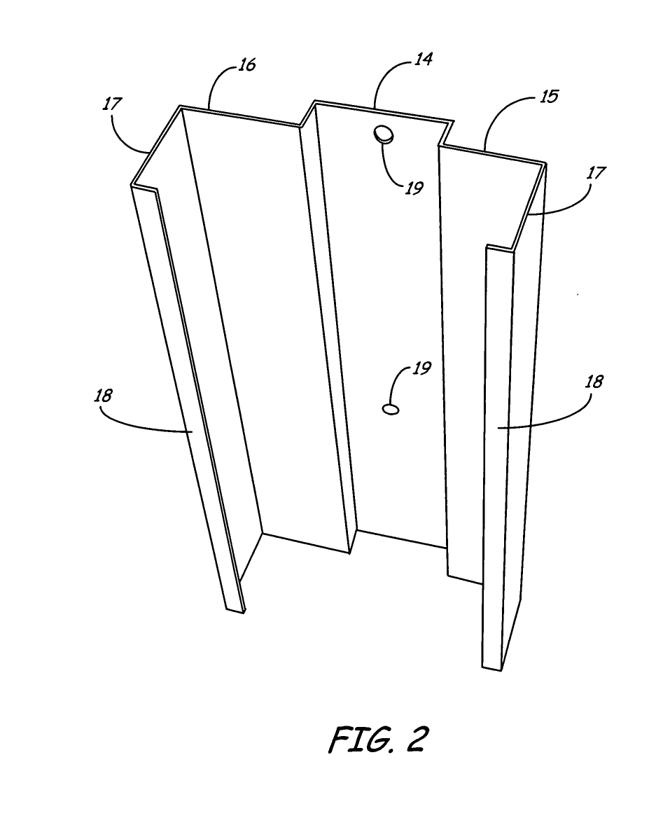

In many applications, particularly commercial applications, door frame components are channel shaped and fabricated of metal. Referring to FIG. 2, such door frame components consist of a protruding intermediate striker portion 14, shoulder portions 15, 16 extending outwardly on either side of striker portion 14, end flanges 17 on the outer ends of shoulder portions 15, 16 and extending at right angles thereto, and inwardly extending returns 18 on the ends of flanges 17 opposite shoulder portions 15, 16. Holes 19 are drilled or otherwise formed through the striker portion 14 at various locations for the purpose of inserting fasteners to fasten the component to the structural component of a wall.

The height of the component as measured from the interior side of striker portion 14 and the plane of returns 18 is designated H. The width of the component as measured from the outer ends of returns 18 is designated W. In most instances, H is on the order of 2½ inches and W is on the order of 5¾ inches. Those dimensions may vary, however, depending upon the particular needs of the specific installation. For instance, W may be as large as 8¾ inches in some installations.

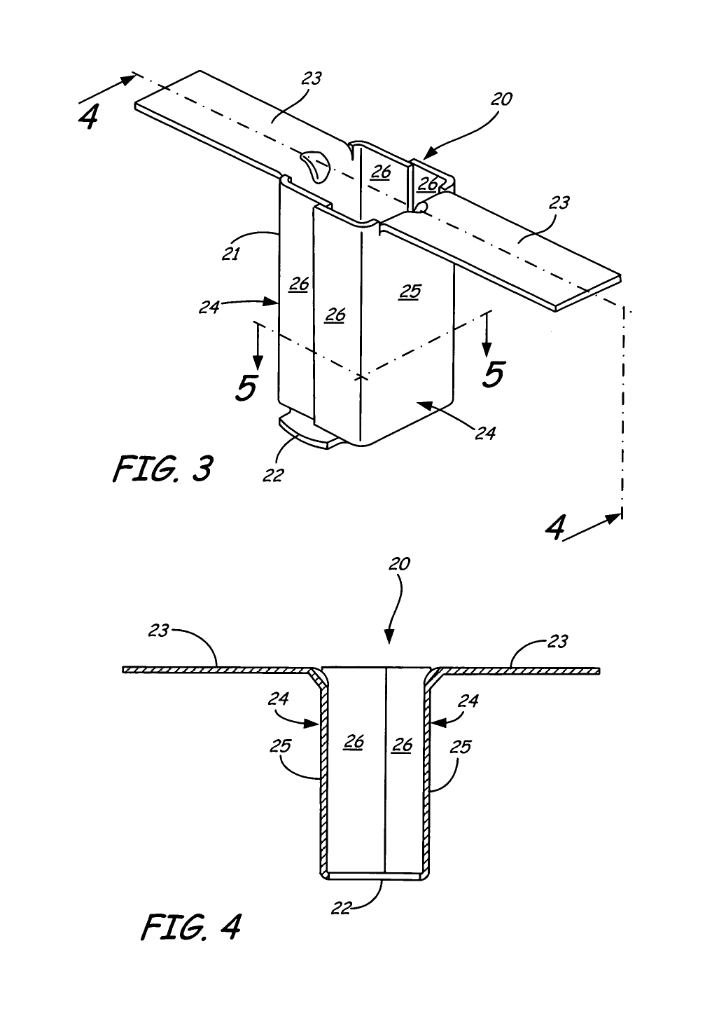

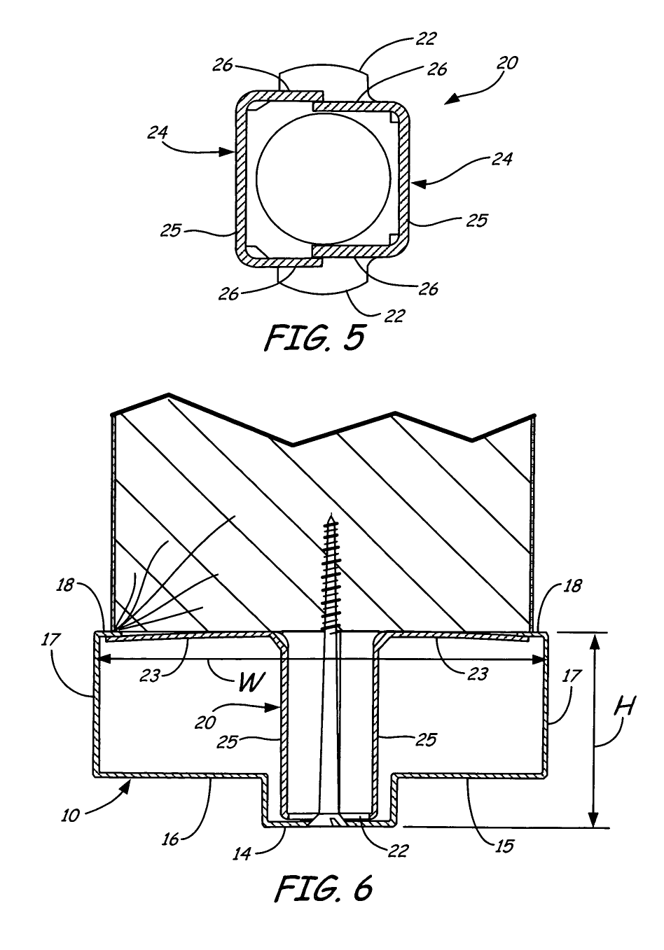

Referring to FIG. 3, an anchor 20 is provided for the purpose of supporting the striker portion 14 of a metal door frame component against buckling or bending when a fastener is inserted through a hole 19 and tightened to attach the component to a structural component of a wall. Anchor 20 comprises an elongate, hollow tubular portion 21, a base 22 with a central hole formed at one end of tubular portion 21 and a pair of outwardly extending flanges 23 at the other end of tubular portion 21. In the preferred embodiment, tubular portion 21 has a generally square or rectangular cross-section formed by generally “U” shaped sides 24, each having an intermediate web portion 25 and two legs 26 extending at right angles to the web portion 25. The space between legs 26 in one side 24 is slightly less than the space between legs 26 in the other side 24, such that the outer ends of legs 26 of the former fit within the outer ends of legs 26 of the latter. Such overlap adds additional strength to anchor 20.

The height of anchor 20 as measured from the top of flanges 23 to the bottom of base 22 is substantially the same as the height H of the particular metal door frame component with which the anchor 20 is intended to be used and the width of anchor 20 as measured from the outer ends of flanges 23 is slightly less than the width of such metal door frame component.

In use, the anchor 20 is inserted into the door frame component with flanges 23 aligned longitudinally within the channel and base 22 adjacent a hole 19 in striker portion 14. Anchor 20 is rotated and outer ends of flanges 23 depressed slightly until flanges 23 extend transversely to the channel, within returns 18. When so positioned, the outer end flanges 23 are released thereby holding anchor 20 in position while other anchors 20 are installed, the component is positioned on the structural component of a wall and fasteners inserted into the holes 19 in striker portion 14 and tightened. It will be seen that once so installed, anchors 20 prevent buckling or bending of striker portion 14 upon tightening of such fasteners.

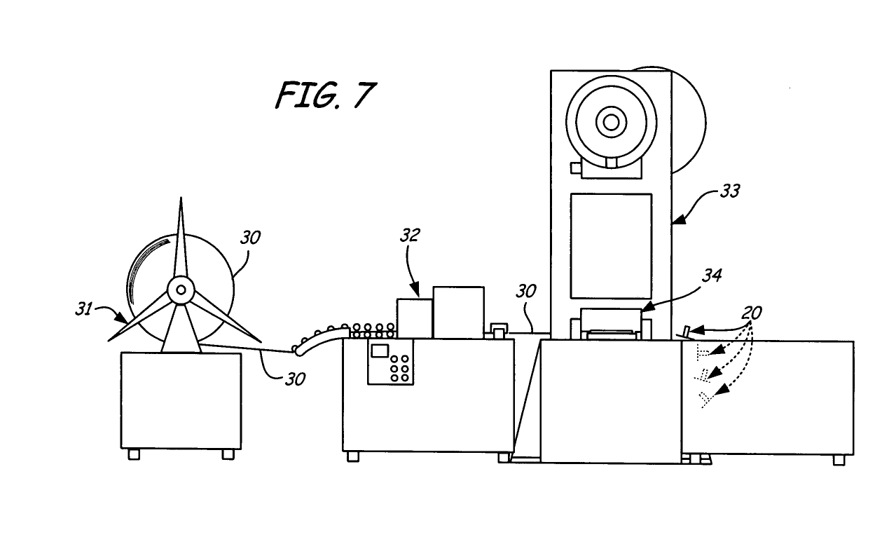

The process for fabricating such anchors 20 is best understood with reference to FIGS. 7 through 9. Referring to FIG. 7, a conventional punch press arrangement is shown comprising a coiled band of steel 30 wrapped on a reel and coil handler 31. The steel band 30 is fed into a computer operated controller 32 that straightens the steel band 30 and controls advancement of steel band 30 through a guide (not shown) into a punch press 33 having a die 34 which is configured in such a manner as to form anchors 20 in the manner herein described.

For conventional 5¾ inch metal door frame components, the width of the steel band 30 is approximately 10¼ inches. For 8¾ inch metal door frame components, the width of the steel band 30 is approximately 13¼ inches.

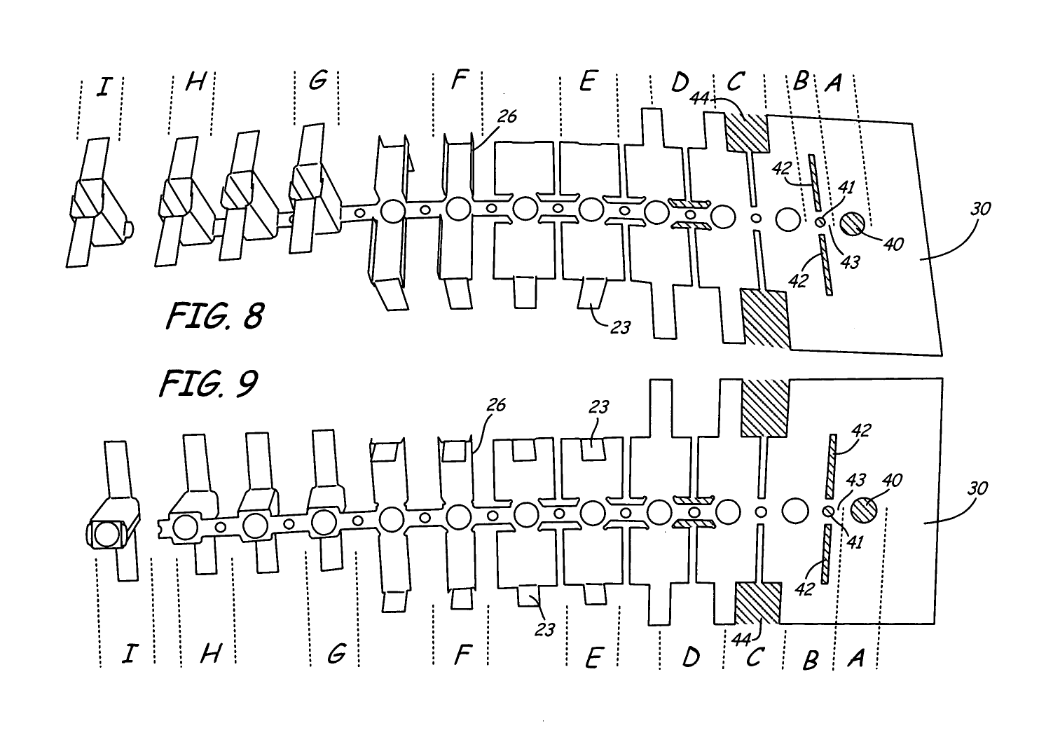

Anchors 20 are formed within die 34 by feeding a steel band 30 through a series of stations within die 34 and performing series of functions on each segment of steel band 30 at each such station. As a result, at any given time, steel band 30 will include multiple segments having anchors 20 in progressing stages of completion. The progression of stages in the fabrication of anchors 20 according to the present invention is shown in FIGS. 8 and 9.

Initially, steel band 30 is fed through controller 32 which acts to flatten band 30 so as to take out any curve imparted by coiling, to align band 30 with the entrance into die 34 and to control the advancement of band 30 through die 34. Each time press 33 cycles, controller 32 advances band 30 to move each segment of band 30 to the next station and, when so advanced, controller 32 signals press 33 to cycle again so as to perform the next function on each respective segment of band 30. The typical travel between stations is on the order of 2½ inches.

As seen in FIGS. 8 and 9 in the preferred embodiment, there are 13 basic stations within die 34 at which the various functions used to fabricate anchors 20 according to the present invention are accomplished. Punching, trimming or bending functions are done at eight of those stations, which will be referred to as “punch stations” and are designated in FIGS. 8 and 9 by the letters A through I. The function accomplished at each punch station will be referred to as a “step” designated by the corresponding letter. The process of fabricating an anchor 20 according to the present invention will be described with respect to a single segment of band 30, with the understanding that while a particular function is being performed on any given segment within die 34, the preceding and subsequent functions in the process are being performed on the segments behind and in front of that segment, respectively. Material being removed in the process is designated in cross-hatching at the station at which such material is removed.

At punch station A, a base hole 40 is punched along the centerline of band 30 (step A).

Upon completion of step A and cycling of press 33, an index hole 41 and segment cutouts 42 are removed on either side of index hole 41 which serve to partially separate one segment of band 30 from the following segment while leaving a web 43 surrounding index hole 41 still connecting the two segments (step B).

Once press 33 has cycled to perform step B, controller 32 advances the segment to punch station C. At punch station C, flange cutouts 44 are removed on the outer portions of band 30 between adjacent segments so as to define flanges 23 (step C).

Upon completion of step C, controller 32 advances the segment to punch station D, at which portions of web 43 are removed, still maintaining a portion of web 43 connecting the adjacent segments of band 30 (step D).

After step D, the controller 32 advances the segment to a first guide station at which a guide pin is inserted into index hole 41 to assure that the segment is in proper alignment.

When press 33 cycles again, the segment is advanced to punch station E, at which press 33 is cycled to bend flanges 23 downwardly with respect to sides 24 (step E).

After step E, the segment is advanced to a first flex station at which no functions are performed and at which no portion of die 34 contacts the segment. The purpose of the first flex station is to permit the segment to flex vertically while step E and step F are performed on the following and preceding segments of band 30, respectively.

When press 33 cycles again, controller 32 advances the segment to punch station. F, at which press 33 is cycled to bend legs 26 upwardly at right angles to intermediate web portion 25 of each side 24 (step F).

Upon completion of step F, controller 32 advances the segment to a second guide station at which a guide pin is again inserted into index hole 41 to assure the segment is in proper alignment.

When press 33 cycles again, controller 32 advances the segment to punch station G, at which press 33 is cycled to bend web portions 25 of sides 24 upwardly at right angles to base 22 such that ends of legs 26 of one side 24 extend within the end of legs 26 of the other side 24 (step G).

Upon completion of step G, controller 32 advances the segment to a second flex station at which no functions are performed, but the segments are permitted to flex vertically.

When press 33 cycles again, controller 32 advances the segment to a third guide station wherein a guide pin is inserted into index hole 41 to assure the segment is in proper alignment.

When press 33 cycles again, controller 32 advances the segment to punch station H, at which the segment is formed into its final shape by squaring up the tubular portion (step H).

Upon completion of step H, controller 32 advances the segment to punch station I, at which the remaining portion of web 43 is removed so as to sever the completed anchor 20 from the rest of band 30, which falls into a container in a completed state (step I).

In atypical installation, a door is attached to the hinge jamb of the door frame assembly by hinges, one wing of each hinge being attached to a side of the door and the other wing of each hinge being attached to shoulder portion 15. The width of shoulder portion 15 is substantially as equal to the width of the door, such that the door is flush with the frame assembly when the door is closed. The width of shoulder portion 16 will depend upon the thickness of the wall and the thickness of the striker portion 14 of the door frame component. Although shown in the drawings as being substantially equal, shoulder portions 15, 16 are often of different widths, depending upon the relative thickness of the door and wall with which they are used. Anchors 20 used in conjunction with door frame components having shoulder portions 15, 16 with different widths will have to have flanges 23 of different lengths. In order to fabricate anchors 20 having flanges 23 of different lengths, the guide by which steel band 30 is fed into die 34 is simply moved sideways until located at a position that results with flanges 23 having the desired lengths.

In most applications, the overall width of the door frame components will be approximately 5¾ inches. In some instances, however, the width of the wall is such that the overall width of the door frame components will have to be larger, most often 8¾ inches, but 6¾ inches or 7¾ inches on occasion. For anchors 20 for use in door frame components having a width of 5¾ inches, the width of the steel band 30 will have to be approximately 10¼ inches. For anchors 20 for use in door frame components having a width of 8¾ inches, the width of the steel band 30 will be approximately 13¼ inches. For anchors 20 for use in door frame components having widths of 7¾ inches or 6¾ inches, marks at ½ inch increments from the end of each flange 23 may be placed during the stamping process on the larger anchors 20 (formed from a 13¼ inch steel band) to permit the flanges 23 to be shortened to the desired length by cutting.

While I have described the preferred embodiment of my invention, it will be evident to those skilled in the art that other embodiments may be possible within the scope of my invention.

What is claimed is:

1. An anchor for supporting a metal door frame component from buckling or bending upon tightening of a fastener attaching the door frame component to a wall, comprising:
(a) a hollow intermediate portion;
(b) a base portion formed on one end of said intermediate portion and having an opening aligned with said intermediate portion; and
(c) a pair of opposed flanges extending outwardly and at right angles from the other end of said intermediate portion;
wherein the height of said anchor is substantially equal to the height of said door frame component and the width of said anchor is substantially equal to the width of said door frame component.

2. An anchor for supporting a metal door frame component from buckling or bending upon tightening of a fastener attaching the door frame component to a wall according to claim 1 wherein said hollow intermediate portion of said anchor comprises a pair of opposed channel shaped sides and the open end of one of such sides is received within the open end of the other of said sides.

3. An anchor for supporting a metal door frame component from buckling or bending upon tightening of a fastener attaching the door frame component to a wall, comprising:
(a) a hollow intermediate portion comprising a pair of spaced, opposed generally “U” shaped sides, each of said sides having a central web portion and spaced legs extending at right angles from the outer edges of said web portion, wherein the open end of one of said sides is received within the open end of the other of said sides;
(b) a base portion formed on one end of said intermediate portion and having an opening aligned with said intermediate portion; and
(c) a pair of opposed flanges extending outwardly and at right angles to the web portions of each of said sides opposite said base portion;
wherein the height of said anchor is substantially equal to the height of said door frame component and the width of said anchor is substantially equal to the width of said door frame component.

4. A process for fabricating anchors for supporting a metal door frame component from buckling or bending upon tightening of a fastener attaching the door frame component to a wall out of a segment of metal ribbon, wherein said anchors have a hollow intermediate portion, a base located on one end of said intermediate portion and having an opening aligned with said intermediate portion, and a pair of opposed flanges extending outwardly from the other end of said intermediate portion, said process comprising the steps of:
(a) removing a central, base opening for each anchor;
(b) removing first transverse webs of metal between successive anchors to define sides of intermediate portions of successive anchors on either side of said base opening;
(c) removing second transverse webs of metal at the outer ends of said first transverse webs, said second transverse webs being wider than said first transverse webs, so as to define flanges extending outwardly from the center of each side;
(d) removing longitudinal webs of metal at the inner ends of said first transverse webs;
(e) bending said flanges downwardly at right angles to said side;
(f) bending the outer edges of each of said sides upwardly to define central web portion and spaced legs extending at right angles thereto; and
(g) bending the web portions of sides upwardly at right angles to said base portion.
